(19) United States
(12) Patent Application Publication
(10) Pub. No.: US 2001/0043939 A1
(43) Pub. Date: Nov. 22, 2001

(54) PROCESS FOR PRODUCING ENTOMOPATHOGENIC NEMATODE PREPARATION AND METHOD OF STORING THE SAME

(76) Inventors: MINEO TACHIBANA, IBARAKI (JP); LESLIE INDRASITH, IBARAKI (JP); NOBUKAZU SUZUKI, IBARAKI (JP); ICHIRO ASANO, IBARAKI (JP)

Correspondence Address: JANIS K FRASER, FISH & RICHARDSON, 225 FRANKLIN STREET, BOSTON, MA, 021102804

(21) Appl. No.: 09/051,823

(22) PCT Filed: Oct. 22, 1996
(86) PCT No.: PCT/JP96/03067

§ 371 Date: None

(30) Foreign Application Priority Data
Oct. 25, 1995 (JP) 7278147

(51) Int. Cl. A01N 25/00; A01N 25/26; A01N 25/28; A01N 25/08

(52) U.S. Cl. 424/421; 424/405; 424/409; 119/6.7

(57) ABSTRACT

A process for producing a pesticide preparation, comprising steps of maintaining a mixture of an entomopathogenic nematode, clay, and water under the conditions to prevent drying at the first temperature for inactivating said nematode for a predetermined period of time and further maintaining the mixture under the conditions to prevent drying at the second temperature lower than said first temperature for inactivating said nematode for a predetermined period of time was developed. The present invention provides an entomopathogenic nematode preparation comprising a nematode with good preservability and clay.

### TECHNICAL FIELD

The present invention relates to a biological control agent used for exterminating pest insects. More specifically, this invention relates to an entomopathogenic nematode preparation used for exterminating pest insects.

### BACKGROUND ART

In general, nematodes are classified, depending on their parasitizing subjects, mainly into the free-living nematode, plant-parasitic nematode, and insect-parasitic nematode, or entomopathogenic nematode. Although the crop-damaging Meloidogyne is plant-parasitic, bacterium-predating nematodes which phagocytize pathogenic microorganisms of crops (e.g., Aphelenchus avenae) and entomopathogenic nematodes which parasitize and kill pest insects (genus Steinernema, genus Heterorhabditis) are highly demanded for their development as biological control pesticides, or insecticides, taking advantage of their properties. Especially, certain species of entomopathogenic nematodes have already been put to practical use and may be promising biological control materials.

Under the conditions where entomopathogenic nematodes are present along with host insects, they intrude into the insect hemocoel through insect's mouth parts, anal pit, leg joints, etc., where they discharge symbiotic bacteria preserved within their bodies, proliferate after demolishing the insect's immune system, and lead to the death of host insect. Only the nematode at the stage of the “infectious third-instar larva” is infectious to insects in their life cycle. Infectious third-instar larvae is covered with the exuvium of the second-instar larva (sheath) having durability in various adverse environments.

There have hitherto been known several methods for preventing and terminating the plant-damaging pest insects utilizing this infectious third-instar larva and its culture in a large scale has already been carried out with the artificial nutrition. In general, after manufacturing the preparation of cultured nematodes in a form durable for the long-term preservation, they are applied to the field.

In several conventional embodiments for preserving entomopathogenic nematodes exemplified by those described below, nematodes are preserved by:

1. a method of preserving nematodes suspended in distilled water under an aerobic condition (S. R. Ducky, J. V. Thompson, George E. Cantwell, J. Insect Pathology, No. 6, p417, 1964),

2. a method of penetrating nematodes suspended in distilled water into a carrier such as polyurethane foam and placing said carrier in an aerated bag (Bedding, R. A., Ann. Appl. Biol., Vol. 104, No. 1, p117, 1084),

3. a method of mixing nematodes with adsorbent such as active charcoal (Japanese Patent Laid-Open Publication No. Sho 61-501392, Specification of International Patent Laid-Open Publication No. 85/03412),

4. a method of homogeneously mixing clay with nematodes and adjusting the water content (Japanese Patent Laid-Open Publication No. Sho 2-503913, Specification of International Patent Laid-Open Publication No. 88/08668),

5. a method of enclosing nematodes in beads or film of alginic acid gel (Kaya, H. K., Nelson, G. E., Env. Entomol., Vol. 14, No. 5, p.572, 1985; Japanese Patent Laid-Open Publication No. Sho 62-116501; Specification of United States Patent No. 4615883; Japanese Patent Laid-Open Publication No. Sho 4-505701; International Patent Laid-Open Publication No. 90/10063),

6. a method of drying nematodes (Japanese Patent Laid-Open Publication No. Hei 2-501300; Specification of International Patent Laid-Open Publication No. 88/01134; Japanese Patent Laid-Open Publication No. Sho 3-503526; Specification of International Patent Laid-Open Publication No. 89/00460; Specification of International Patent Laid-Open Publication No. 89/08704), or

7. a method of preventing the water-evaporation with oil (Japanese Patent Laid-Open Publication No. Sho 52-41225).

However, in Embodiment 1, the use of an aeration equipment is necessary and this method is not suitable for the transportation of a large quantity. Embodiment 2 is troublesome since nematodes must be taken out from sponge prior to the treatment in the field. Embodiment 3 is applicable only for specific nematodes, and also problems imposed on the processability of active carbon have been indicated. In fact, the present inventors attempted to preserve S. kushidai in accordance with this Embodiment, resulting in a very unsatisfactory preservability. In Embodiment 5, the preparation must be suspended in a solution containing a univalent ion such as sodium citrate to dissolve gels prior to its application, making its manufacture in a large quantity difficult. Embodiment 6 requires to set up strict environmental conditions such as humidity, temperature, etc. for appropriately drying nematode. Embodiment 7 is to temporarily prevent drying up nematodes applied on plant leaves, not usable for a long-term preservation over several months.

Embodiment 4 using clay can be said to be promising since this method can be carried out inexpensively with good processability as compared with the method using active charcoal. However, if clay with a small particle diameter is used, this method has a drawback that a rapid migration of water from nematodes to clay is caused, which damages the nematodes. On the other hand, in the case of the use of clay with large particle diameter for the treatment in the practical field such as farm and lawn, these preparations have to be first diluted with water and then sprayed. If not, such a problem occurs that the original suspension tends to plug the spray nozzle pore of ordinary drug sprayer or sprinkler with clay.

In order to solve these problems, the present inventors have developed and filed for the patent application, as an improvement of Embodiment 4, a process for producing an insecticide preparation comprising steps of bringing a mass of entomopathogenic nematodes retaining the surface water into contact with clay and allowing the nematodes to migrate into clay. Since, according to this method, nematodes in the preparation have good preservability and the particle diameter of clay can be made small, this method can be said to be a highly practical and excellent method. However, the preservability of the preparation manufactured by the method of Embodiment 4 or its improved method still has much to be elucidated and it has been highly desired to improve the preservability as much as possible.

### Disclosure of the Invention

An object of the present invention is to provide an entomopathogenic nematode preparation with excellent preservability comprising an entomopathogenic nematode and clay.

As a result of intensive studies, the present inventors have developed a process for producing an insecticide preparation comprising steps of maintaining a mixture of entomopathogenic nematode, clay, and water (hereafter may be referred to simply as “mixture”) under the conditions to suppress drying at the first temperature for inactivating the nematode for a predetermined period of time, and further maintaining the mixture under the conditions to suppress drying at the second temperature lower than the first temperature for inactivating the nematode for a predetermined period of time, thereby accomplishing the present invention.

In general, entomopathogenic nematodes become inactivated (referring to the state where nematodes are slow in motion, and their oxygen demand and energy metabolism are suppressed) below a specific temperature (for example, about 10 `15 or lower for S. kushidai). This invention features that the “mixture” is maintained at the first temperature for inactivating the nematodes for a predetermined period of time, and further, under the conditions to prevent drying, maintained at the second temperature lower than the first temperature for a predetermined period of time. Therefore, the present invention features that, instead of acutely exposing the “mixture” to a low temperature, the nematodes are, after being acclimatized to the first temperature, maintained at the second temperature lower than the first temperature so that the damage of nematodes due to the low temperature can be reduced. In addition, modified methods in which nematodes are maintained, after maintaining at the second temperature, further once or plural times at temperatures different from the second temperature are also within the scope of this invention.

The “mixture comprising entomopathogenic nematode, clay, and water” used in the present invention is exemplified by the one prepared by the above-described method in which clay and nematodes are homogeneously blended with the water content being adjusted (Japanese Patent Laid-Open Publication No. Sho 2-503913, Specification of International Patent Laid-Open Publication No. 88/08668) or by the “improved method” according to the present inventors.

The “improved method” according to the present inventors means “a process for producing an insecticide preparation which comprises steps of bringing a mass of entomopathogenic nematodes retaining the surface water into contact with clay and allowing them to move into clay”. This improved method (hereinafter sometimes simply abbreviated as “improved method”) will be described below.

In the “improved method”, when a mass of entomopathogenic nematodes (hereinafter sometimes referred to simply as “nematodes”) that retain the surface water are brought into contact with clay, the water first migrates towards clay due to its water-absorbability, forming a concentration gradient of water from the mass of nematodes towards the outside of clay. Under these conditions, by suppressing drying up of the preparation and allowing it to stand at the temperature optimal for the nematode activity, usually at 25 `28, nematodes start to migrate from the mass to clay in the opposite direction to that of the concentration gradient of water seeking the oxygen. These conditions can be attained, for example, by placing a mixture of nematodes and clay in a bag made of aerated film or a container partially made of aerated film, and allowing it to stand in a chamber with the relative humidity of 95% or higher. Also, if it is for a short while, the conditions can be attained by a gentle intermittent stirring of a mixture of nematodes and clay placed in a container with a lid in a room. In this occasion, the surface water of migrating nematodes is gradually absorbed into clay, and nematodes cease to migrate when the water concentration reaches the level that stops the nematode migration. Since nematodes which have stopped the movement are now surrounded with clay which has been equilibrated with water, they will be exposed to no further dryness, and preserved under moisturized conditions optimal for their inactivation. Nematodes under these conditions are at a stop in motion and in a state of diapause, resulting in the enhancement of the preservability in the preparation. Although the time required to reach this state varies depending on the species of nematode, type of water absorbent used, or mass size and concentration of nematodes, it is about 15 min `24 h, usually 30 min `12 h. Also, in this invention, the particle diameter of clay is not particularly limited, but it is preferably not more than 100 m, and more preferably not more than 10 m.

In one embodiment of the “improved method” is exemplified a method comprising the steps of, prior to bringing clay into contact with nematodes, retaining them once in a water-absorbent, and contacting said nematodes retained in the water-absorbent and water with clay. Preferable examples of the water-absorbent include polyurethane foam, cellulose sponge, paper chip, wood chip, chip, fiber, macromolecular absorbent, etc. Although the concentration of nematode suspension to be retained in the water-absorbent varies depending on the type of water-absorbent, nematode species to be used, and the concentration of nematodes in the desired final preparation, the suspension is preferably condensed to about 20 `2,000,000 nematodes/ml (in liquid).

This method features that, when nematodes retained in the water-absorbent and water are brought into contact with clay, water first migrates from the absorbent to clay due to the clay's absorbency, and then the water movement is equilibrated at a certain level due to the water-retaining capability of the absorbent, forming a stable concentration gradient of water from the water-absorbent towards the outside of clay. Clay may be either dried or slightly moisturized (about 1 `5%). Nematodes migrating from the water-absorbent into clay ultimately stop to move at the water concentration which can bring them to a stop. Since nematodes which have stopped the movement are now surrounded with clay which has been equilibrated with water, they will be exposed to no further dryness, and preserved under moisturized conditions optimal for their inactivation.

In addition, after the migration of nematodes, the water-absorbent is preferably separated from the clay using a sieve with 1 `5 mm mesh. At this time, not less than 90% nematodes are recovered in the clay, and those remaining in the water-absorbent can be recovered as a suspension by soaking them again in water. Also, water-absorbent such as polyurethane foam, cellulose sponge, etc. can be reused by drying them in dryer after washing. Thus, a powdered preparation with clay, moisture and nematodes being homogeneously distributed therein can be obtained by separating it using a sieve. Since, in such a preparation, small-particle clay and nematodes mutually form a steric structure, they can provide spaces to supply enough oxygen to nematodes.

Another embodiment of the “improved method” is a method comprising the steps of dehydrating a suspension of cultured nematodes to a clod and embedding this nematode clod in clay. The suspension is preferably concentrated and dehydrated to about 40 `4,000,000 nematodes/ml (in the form of clod), though the content may vary depending on the species used. When this nematode clod is placed in clay the water content of which has previously been adjusted to 10 `30% to prevent dehydration and allowed to stand, water migrates from the nematode clod to clay, forming a concentration gradient of water. Nematodes which migrate from the clod to clay ultimately cease to move at the water concentration capable of stopping the nematode movement. This method is advantageous in that the production process is simple because of using no water-absorbent.

In the present invention, “the first temperature” and “the second temperature” vary in their optima depending on the species of nematodes, type of preparation, etc. For example, in the case of S. kushidai, about 10 `15 is preferable for the first temperature and about 1 `5 for the second temperature, and in the cases of S. Glaseri and S. carpocapsae, similar temperature ranges are preferable.

In addition, although the optimal period of time during which nematodes are maintained at the first temperature or the second temperature also varies depending on the species of nematodes, type of preparation, etc., it is generally desirable to maintain them at the first temperature for at least more than one week. For example, it is desirable for S. kushidai to be maintained for about 7 `14 days in the first period, and about 7 `14 days for the second period. With S. Glaseri and S. carpocapsae, similar periods of time are preferable.

Also, in order to suppress the drying of the “mixture” during its maintenance at the first temperature and the second temperature, it is desirable to place the “mixture” in a bag made of slightly aerated film such as polyfilm or a container partially made of slightly aerated film and allow it to stand in an atmosphere of relative humidity of not less than 70%.

Furthermore, in order to suppress the drying of the “mixture” during its maintenance at the first temperature and the second temperature, it is desirable to place the “mixture” in a bag made of aerated film or a container partially made of aerated film and allow it to stand in an atmosphere of relative humidity of not less than 95%.

Although the preparation manufactured by the present invention can be stored at the room temperature for a certain period of time, it is preferable to store it at low temperature. The preferred temperature for storing the preparation is generally similar to the second temperature, and is about 1 5 in the case of S. kushidai, and a similar temperature range is preferred also in the cases of S. Glaseri and S. carpocapsae. Furthermore, S. kushidai and H. bacteriphora have been thought to be too labile to low temperature to be stored below 5 even by any methods, and this invention is the first enabling the storage of these low temperature-labile nematodes at low temperature. In addition, in order to prevent drying, it is desirable to store the preparation in a tightly closed container.

### BEST MODE FOR CARRYING OUT THE INVENTION

The present invention will be further described below with reference to the following Examples, which are not to be construed to limit the scope of the invention.

### EXAMPLE 1

### Production Process Using Cellulose sponge

Eight ml of nematode cream containing 10,000,000 S. kushidai was thoroughly absorbed into 0.65 g of cellulose sponge (5-mm dice), and mixed with 17 g of dried clay (containing an antifungal agent). After storing this mixture under these conditions for 24 h (at 25, in an atmosphere of relative humidity of 95% or higher), the clay containing nematodes was separated from sponge on a sieve (1-mm mesh). The nematode-clay preparation thus manufactured was stored at each temperature indicated in the “maintaining temperature” in Table 1 for each period of time under the conditions of relative humidity of 95% or higher. Thereafter, it was suspended in a suitable amount of water, and a few drops of the suspension applied on a slide glass were examined under microscope to obtain the ratio of viable nematodes. The results are shown in Table 1.

### EXAMPLE 2

### Production Process Using Wet Clay

To dried clay (containing an antifungal agent) was dropwise added water in an amount of 15% (weight ratio), and wet clay was first prepared by homogeneously pulverizing the above mixture in a blender. About 5 g of clods of S. kushidai (comprising 10,000,000 dehydrated and sieved nematodes) was placed in 27 g of the wet clay thus prepared and they were briefly mixed. After the mixture in this state was placed in an aerated bag for 24 h (at 25, in an atmosphere of relative humidity of 95% or higher), the particle diameter of the preparations were unified using a sieve (1-mm mesh). The nematode-clay preparation thus manufactured was stored at each temperature indicated in the “maintaining temperature” in Table 1 for each period of time in an atmosphere of relative humidity of 95% or higher. Thereafter, the preparation was suspended in an appropriate amount of water. A few drops of the suspension were applied to a slide glass, and examined under a microscope to obtain the ratio of viable nematodes. The results are shown in Table 1.

### EXAMPLE 3

### Production Process using Wet Clay

To dried clay (containing an antifungal agent) was dropwise added water in an amount of 12% (weight ratio) and wet clay was first prepared by homogeneously pulverizing the above mixture in a blender. Fifty-seven g of clods of S. kushidai (comprising 114,000,000 dehydrated and sieved nematodes) was placed in 160 g of the wet clay thus prepared and they were briefly mixed in a beaker using a spatula. The top of the beaker was covered with a piece of aluminum foil, and stored at 25 for 1 h with a brief mixing using a spatula once every 15 min. Then, the particle diameter of the preparation was unified using a sieve (1-mm mesh). The nematode-clay preparation thus manufactured was placed in polyfilm bag (slightly aerated), and stored under the conditions at maintaining temperatures shown in Table 1 for a period of each indicated time in an atmosphere of relative humidity of 70% or higher. Then, a few drops of the preparation suspended in a suitable amount of water were applied to a slide glass, and examined under a microscope to find the ratio of viable nematodes. The results are shown in Table 1.

TABLE 1

| | | Nematode | Preserving days | | | | | | | | | | |
|---|---|---|---|---|---|---|---|---|---|---|---|---|---|
| Preparation | Maintaining | conc. | 10 | 20 | 30 | 40 | 50 | 60 | 90 | 120 | 150 | 180 | 210 |
| method | temperature | (nematodes/g) | days | days | days | days | days | days | days | days | days | days | days |
| Example 1 | 15 (10 days) ″5 | 292,000 | 97.5 | 93.5 | 93.9 | 100 | 91.7 | 100 | 88.0 | 87.5 | 88.0 | 85.6 | 78.9 |
| Example 1 | 15 | 292,000 | 99.3 | 97.5 | 93.7 | 91.4 | — | 86.2 | 80.6 | 76.5 | 59.2 | 42.0 | 17.6 |
| Example 2 | 15 (10 days) ″5 | 307,000 | 98.1 | 93.1 | 96.3 | — | — | 93.3 | 90.2 | 86.0 | 90.0 | 81.0 | 78.7 |
| Example 2 | 5 | 307,000 | — | — | 37.0 | — | — | 0.0 | — | — | — | — | — |
| Example 2 | 15 | 307,000 | 99.9 | 95.1 | 94.6 | — | — | 88.0 | 78.0 | 75.0 | 67.0 | 52.4 | 29.8 |
| Example 2 | 25 | 307,000 | 99.7 | 84.6 | 66.9 | — | — | 21.6 | — | — | 4.7 | — | — |
| Example 3 | 15 (10 days) ″5 | 456,000 | — | — | 93.3 | — | — | 89.4 | — | 89.5 | 85.7 | | |

Numerals before the arrow represent the temperature (corresponding to “the first temperature” used herein) and the number of days at and for which the preparation was maintained prior to the initiation of counting the preservation days. The temperature after the arrow and temperature singly shown represent those at which the preparation was maintained after the initiation of counting the preservation days.

The results shown in Table 1 clearly indicate that nematodes prepared according to the process of the present invention have better surviving rates than those in the preparations maintained at the constant temperature.

### Industrial Applicability

The present invention has enabled the manufacture of the preparation having the improved preservability of nematodes and excellent practical use.

1. A process for producing a pesticide preparation, comprising steps of maintaining a mixture of an entomopathogenicparasitic nematode, clay, and water at the first temperature for inactivating said nematode for a predetermined period of time under the conditions that the mixture is prevented from drying, and further maintaining the mixture at the second temperature lower than said first temperature for inactivating said nematode for a predetermined period of time under the conditions that the mixture is prevented from drying.

2. The method according to claim 1, wherein said mixture is maintained at the first temperature for 1 week or longer.

3. The method according to claim 1, wherein said entomopathogenic nematode is S. kushidai.

4. A method of preserving a pesticide preparation manufactured by the method according to claim 1, wherein the pesticide preparation manufactured by the method according to claim 1 is preserved in a tightly closed container.

5. A method of preserving a pesticide preparation manufactured by the method according to claim 1, wherein the pesticide preparation manufactured by the method according to claim 1 is preserved at low temperature.
